(19) United States
(12) Patent Application Publication
(10) Pub. No.: US 2014/0232183 A1
(43) Pub. Date: Aug. 21, 2014

(54) ELECTRIC VEHICLE

(71) Applicant: Kentaro Hirose, Aichi-gun (JP)

(72) Inventor: Kentaro Hirose, Aichi-gun (JP)

(21) Appl. No.: 14/346,048

(22) PCT Filed: Sep. 21, 2011
(86) PCT No.: PCT/JP2011/071430

§ 371 Date: Mar. 20, 2014

(51) Int. Cl. B60L 3/04

(52) U.S. Cl. CPC B60L 3/04
USPC 307/10.1

(57) ABSTRACT

There is provided a technology of preventing a discharging device from being damaged by induced current caused by back electromotive force of a motor in an electric vehicle including the discharging device for discharging a capacitor in collision. A hybrid vehicle includes a capacitor, a current sensor, a discharging circuit, and a controller. The capacitor is connected to an input side of the inverter. The discharging circuit is connected in parallel with the capacitor. The current sensor measures induced current caused by back electromotive force of a motor. When a signal indicating abnormality or collision is inputted, the controller activates the discharging circuit if the induced current measured by the current sensor is less than a predetermined current threshold, and does not activate the discharging circuit if the induced current is greater than the predetermined current threshold.

### TECHNICAL FIELD

The present invention relates to an electric vehicle having an electric motor for driving a wheel. The “electric vehicle” in the description also includes a hybrid vehicle including an engine and a motor for driving a wheel, Furthermore, the “electric vehicle” also includes a fuel cell vehicle.

### BACKGROUND ART

An electric vehicle includes an inverter for converting DC power supplied from a battery into AC power suitable for driving a motor. A capacitor (smoothing capacitor) is generally connected to input terminals of the inverter for restraining a pulsation of current caused by an operation of a switching circuit in the inverter. The electric vehicle may also include a voltage converter for changing an output voltage of the battery at a preceding stage of the inverter. A capacitor (filter capacitor) may also he connected to input terminals of the voltage converter for restraining a pulsation of current caused by an operation of the voltage converter. The capacitors having large capacities are employed since the large power is needed for driving the motor for driving the wheel.

It is preferable for the electric vehicle to include a device (discharging device) for quickly discharging the powers accumulated in the capacitors for ensuring safety of a user upon a collision of the vehicle, or for ensuring the safety of the user in an emergency. For example, Patent Document 1 discloses an electric vehicle including a discharging device. The discharging device is typically a discharging resistor as is disclosed in Patent Document 1.

### CITATION LIST

### Patent Literature

Patent Document 1: Japanese Patent Application Publication No. 2010-193691

### SUMMARY OF INVENTION

The discharging device needs to he connected in parallel with the capacitors, and therefore, as a result, the discharging device is also connected to the input terminals of the inverter. When the motor is rotated in operating the discharging device, induced current caused by back electromotive force of the motor also flows to the discharging device. Consequently, even when a magnitude of current acceptable for the discharging device is greater than a magnitude of current flowing out from the capacitors, in a case where a total of the current flowing out from the capacitors and the induced current is not allowable, there is a concern of damaging the discharging device. For example, when the electric vehicle collides with an obstacle, there may be a case where the wheel (motor) is being rotated by inertia and the induced current is being generated although the inverter is stopped. The description provides a technology for preventing the discharging device from being damaged by the induced current caused by the back electromotive force of the motor.

One aspect of an electric vehicle disclosed in the description includes a capacitor, a current sensor, a discharging device, and a controller. The capacitor is connected between two input terminals of the inverter as described above. The discharging device is connected in parallel with the capacitor. The discharging device may typically be a resistor (discharging resistor). The current sensor measures induced current caused by the back electromotive force of the motor. When a signal indicating abnormality or a signal indicating a collision is inputted, the controller activates the discharging device if the induced current measured by the current sensor is less than a predetermined current threshold, and does not activate the discharging device if the induced current is greater than the predetermined current threshold.

The electric motor determines whether the discharging device is activated in accordance with the magnitude of the induced current caused by the back electromotive force of the motor. Meanwhile, the discharging device is not ordinarily activated. The electric vehicle can protect the discharging device from being damaged since the discharging device is not activated in a case where the induced current is greater than the current threshold.

On the other hand, it is preferable to make use of the discharging device as quickly as possible in a collision or an emergency. Hence, it is preferable that the controller activates the discharging device when either one of the following two conditions is satisfied.
Condition 1: the induced current is less than a first current threshold.
Condition 2: the induced current is less than a second current threshold which is greater than the first current threshold and a decreasing rate of the induced current is greater than a predetermined decreasing rate threshold.

A first current allowable value corresponds to the magnitude of the induced current which the discharging device allows. Condition 2 indicates that even when the current measured by the current sensor is greater than an allowable value of the discharging device, such a state will be immediately resolved. When the magnitude of the induced current is reduced rapidly, a possibility of damaging the discharging device is inconsiderable even if current greater than the allowable value of the discharging device flows for a short period of time. The discharging device can be activated at a timing as early as possible without damaging the discharging device by adopting condition 2.

In another aspect disclosed by the description, it is preferable that the inverter, the capacitor, the discharging device, the current sensor, and the controller are contained in one case. In a case where the electric vehicle collides with an obstacle, there is a possibility of damaging some of the units, Consequently, a possibility of being able to activate the discharging device upon such a collision is higher in a case of containing all of parts related to the discharging device in the single case than in a case of controlling the discharging device by linking the plural units.

Details of a technology disclosed in the description and further improvements will be explained in embodiments of the present invention.

### BRIEF DESCRIPTION OF DRAWINGS

FIG. 1 is a schematic system diagram of a hybrid vehicle;

FIG. 2 is a schematic circuit diagram of an electric power system of the hybrid vehicle;

FIG. 3 is a flowchart diagram of a discharging process; and

FIG. 4 shows an example of a graph of induced current for explaining two current thresholds.

### DESCRIPTION OF EMBODIMENTS

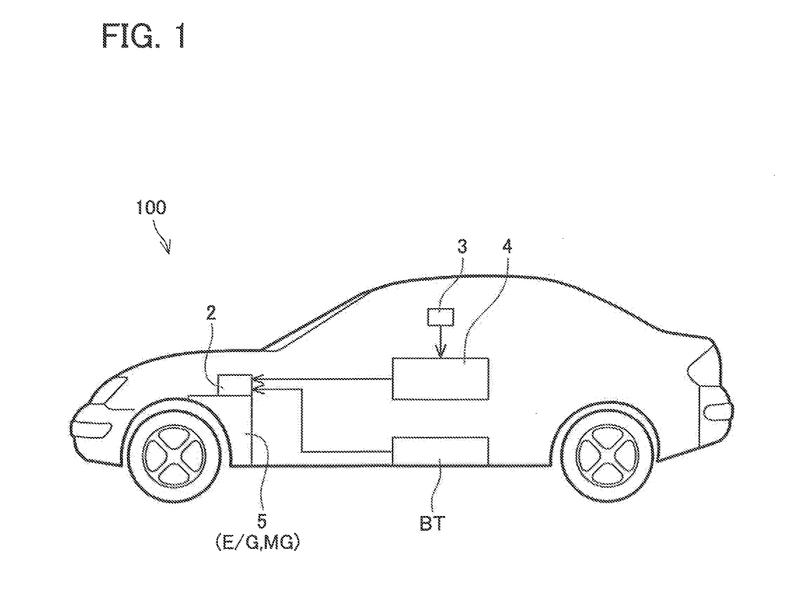

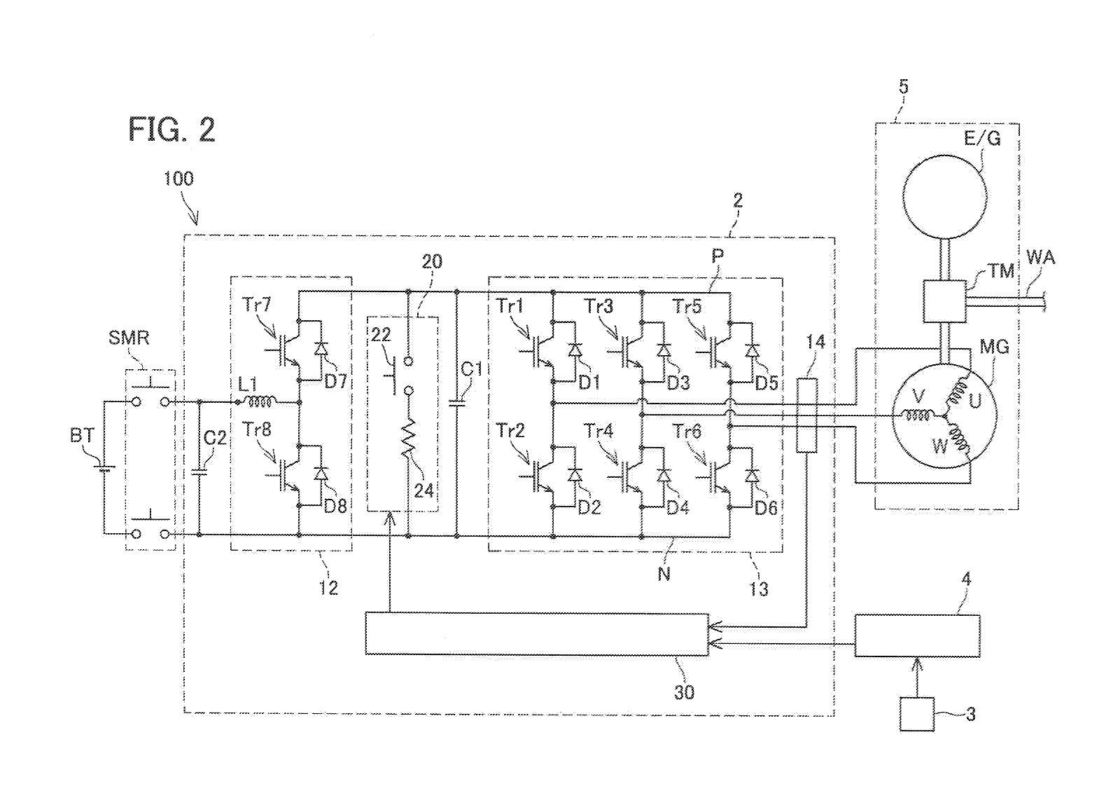

FIG. 1 shows a schematic system diagram of an electric vehicle according to an embodiment. It should be noted that the system diagram of FIG. 1 shows only elements related to the present invention, and does not show all of elements included in the vehicle. The electric vehicle of the present embodiment is a hybrid vehicle 100 including both of an engine and a motor fur driving a wheel. The engine EG and the motor MG configure a drive train 5 along with a power distributor TM (refer to FIG. 2), and mounted in a front compartment. The power distributor TM is a gear unit for distributing or combining outputs of the engine EG and the motor MG to transmit the same to an axle WA. Although a detailed description of a structure thereof will be omitted, the hybrid vehicle 100 can be run only by the engine EG, can be run only by the motor MG, and can be run by a combined force of the engine EG and the motor MG by pertinently controlling the power distributor TM. Also, the hybrid vehicle 100 can drive the motor MG from an output side by utilizing a kinetic energy of the vehicle in braking to thereby generate electricity and charge a battery BT.

A power controller 2 is mounted on the drive train 5. The power controller 2 is implemented with a circuit of a voltage converter (DC-DC converter) for boosting a voltage of the battery BT to a voltage suitable for driving the motor, and a circuit of an inverter for converting DC power into AC power. Also, the power controller 2 is implemented with a discharging circuit for discharging an electric charge accumulated to a capacitor when a signal indicating a collision of the vehicle, or a signal indicating an occurrence of abnormality is inputted to the power controller 2. The signal indicating the collision of the vehicle, or the signal indicating the occurrence of the abnormality is transmitted from an HV controller 4 which is a higher level controller of the power controller 2. The collision of the vehicle is detected by an acceleration sensor 3 provided in an air bag system. A signal of the acceleration sensor 3 is transmitted to the power controller 2 via the HV controller 4. An abnormality signal transmitted to the power controller 2 may include, for example, a signal indicating abnormality of communication between the controllers. Moreover, the power controller 2 always monitors a communication line to the HV controller 4, and determines the occurrence of the abnormality in communication in a case where the communication with the HV controller 4 is interrupted. Also, the HV controller 4 comprehensively controls not only the power controller 2, but the power distributor TM and the engine EG in the drive train 5. The HV controller 4 determines an output of the power controller 2 (that is, a command to the motor), a fuel injection amount to the engine EG, and a power distribution ratio of the power distributor TM to send commands to respective units, on the basis of a remaining charge of the battery BT, an accelerator opening degree, a vehicle speed, and the other vehicle state.

FIG. 2 shows a schematic circuit diagram of an electric power system of the hybrid vehicle 100. FIG. 2 particularly illustrates details of a circuit diagram inside the power controller 2. With giving outline, the power controller 2 includes a voltage converter 12, a discharging circuit 20 (discharging device), an inverter 13, two kinds of capacitors C1 and C2, a current sensor 14, and a controller 30. All the modules are contained in a case of the power controller 2.

The battery BT is connected to the voltage converter 12 in the power controller 2 via a system main relay SMR. The voltage converter 12 is a step up/down converter which can carry out a step up operation of stepping up an output voltage of the battery BT to a voltage suitable for driving the motor, and a step down operation for stepping down a voltage of back electromotive force generated by the motor MG to a voltage of the battery BT. Typically, an output voltage of the battery BT is about 300 V, and a voltage on a high voltage side is about 600V. The voltage converter 12 is configured with a reactor L1, two transistors Tr 7 and Tr 8, and two diodes D7 and D8 as shown in FIG. 2. The circuit of FIG. 2 for carrying out the step up/down operation is well known, and therefore, a detailed description thereof will be omitted.

The filter capacitor C2 is connected to a terminal on a low voltage side (battery BT side) of the voltage converter 12. The filter capacitor C2 is provided for restraining a pulsation of a current caused by the reactor L1.

A terminal on a high voltage side of the voltage converter 12 is connected to an input terminal of the inverter 13. The inverter 13 is configured with 6 transistors Tr1 through Tr6, and 6 diodes D1 through D6 (free-wheeling diodes) as shown in FIG. 2. As shown in FIG. 2, 3 sets of transistor pairs connected in series are connected in parallel. AC powers of 3 phases of UVW are outputted from the respective 3 sets. As is well known, a line passing through the transistors Tr1 through Tr3 on a high potential side is referred to as “upper arm”, and a line passing through the transistors Tr4 through Tr6 on a low potential side is referred to as “lower arm”. Also, a common high potential line supplying a power to the upper arm may be referred to as P line, and a lower potential line common to the lower arm may be referred to as N line. The N line is directly connected to a low potential side terminal of the battery BT. An output of the inverter 13 is supplied to the motor MG. The current sensor 14 is provided on a cable connecting the inverter 13 and the motor MG. The current sensor 14 is a current sensor of a noncontact type using a Hall element. The current sensor 14 is mainly used for a current feedback control of the motor. Data of the current sensor 14 is also used for determining activation/non-activation of the discharging circuit 20 as describe later. That is, the current sensor 14 measures induced current reversely flowing to the inverter 13 owing back electromotive force of the motor.

The smoothing capacitor C1 and the discharging circuit 20 are connected in parallel with each other between the voltage converter 12 and the inverter 13. The smoothing capacitor C1 is provided for smoothing an input current to the inverter 13. The power controller 2 handles a large current for driving the motor for driving the vehicle. Consequently, the filter capacitor C2 and the smoothing capacitor C1 use capacitors having large capacities. It is preferable to quickly discharge electric charges accumulated at the capacitors C1 and C2 in order to ensure safety of a user in an emergency of collision or the like. The discharging circuit 20 is provided for that purpose.

The discharging circuit 20 is configured by a discharging resistor 24 and a switch 22 for connecting and disconnecting the discharging resistor. The switch 22 is controlled by the controller 30. The discharging resistor is made of a metal having a large resistance value and easy to generate heat. In an emergency, an electric charge (electric current) accumulated in the capacitor C1 flows to the discharging resistor 24 by connecting the discharging resistor 24, Also, an electric charge accumulated at the capacitor C2 flows to the discharging circuit 20 through the voltage converter 12 as is apparent from FIG 2. The electric charge accumulated at the capacitor C2 flows to the discharging circuit 20 through the diode D7 even when the voltage converter 12 is not operated. Electric energies accumulated at the capacitors C1 and C2 are converted into heat to be dissipated by the discharging resistor 24.

A maximum allowable current is prescribed for the discharging resistor 24. There is a concern of damaging the discharging resistor 24 when a current greater than the maximum allowable current flows in the discharging resistor 24. On the other hand, when the motor MG is driven from outside (axle side), back electromotive force is generated, and induced current caused by the back electromotive force reaches the discharging circuit 20 by reversely tracing the inverter 13. As is apparent from FIG. 2, the induced current reaches the discharging circuit 20 through the free-wheeling diodes D1 through D6 even when the inverter 13 is not operated. A magnitude of the current flowing when the discharging circuit 20 is activated depends not only on capacitances accumulated in the capacitors C1 and C2 but a magnitude of the induced current caused by the back electromotive force. Therefore, when the discharging circuit 20 is activated in a case of the large induced current, there is a possibility that current greater than the maximum allowable current flows. Hence, the controller 30 determines whether the discharging circuit 20 is to be connected, depending on the magnitude of the induced current.

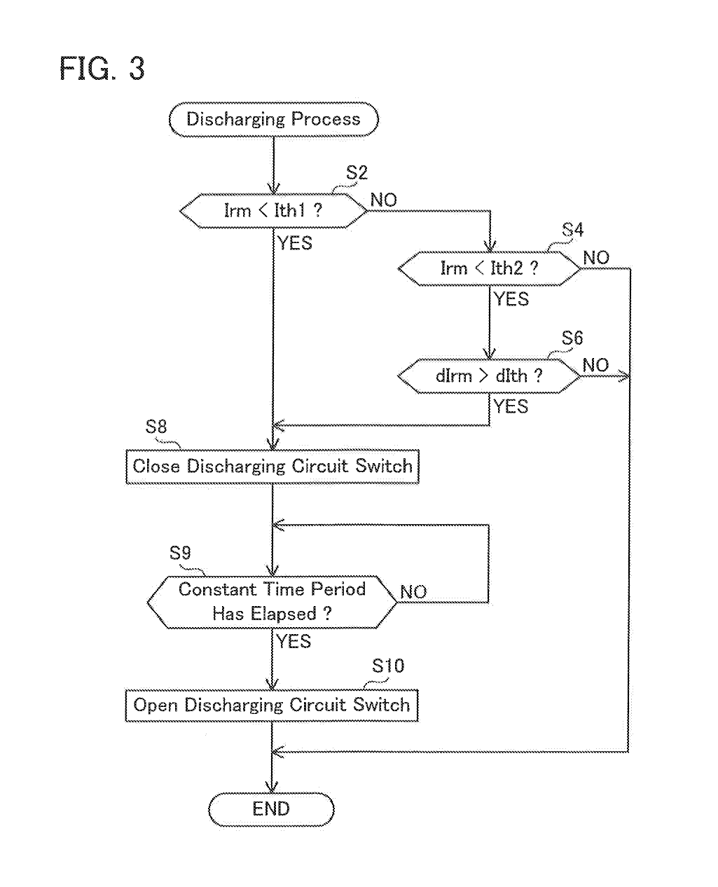

FIG. 3 shows a flowchart of a discharging process. The controller 30 executes the process of FIG. 3. The controller 30 starts the process of FIG. 3, when the controller 30 receives a signal indicating abnormality or collision from the HV controller 4. Meanwhile, the switch 22 of the discharging circuit 20 is ordinarily opened. That is, the discharging circuit 20 is ordinarily disconnected from a system of an electric power system (capacitors C1, C2, the inverter 13).

When the discharging process is started, first, the controller 30 compares induced current km measured by the current sensor 14 with a previously determined first current threshold ITh1 (S2). The first current threshold Ith1 is typically set to a value obtained by subtracting values of current flowing from the capacitors C1 and C2 from a maximum current which can be made to flow constantly to the discharging circuit 20 (discharging resistor 24). In a case where the induced current Irm is less than the first current threshold Ith1 (S2: YES), the controller 30 closes the switch 22 of the discharging circuit 20 (S8). That is, the controller 30 activates the discharging circuits 20. Then, electric charges accumulated in the capacitors C1 and C2 flow to the discharging resistor 24, and powers accumulated at the capacitors C1 and C2 are dissipated. Thereafter, the controller 30 is at standby for a constant period of time (S9), opens the switch 22 of the discharging circuit 20 (S10), and finishes the discharging process.

On the other hand, when the induced current Irm is greater than the first current threshold Ith1 (S2: NO), next, the controller 30 compares the induced current Irm with a second current threshold Ith2 (S4). The second current threshold Ith2 is typically set to a value which is slightly greater than a value obtained by subtracting values of current flowing from the capacitors C1 and C2 from an instantaneous maximum allowable current that can be made to flow to the discharging circuit 20 (discharging resistor 24). Apparently, the second current threshold Ith2 is greater than the first current threshold Ith1.

In a case where the induced current Irm is greater than the second current threshold Ith2 (S4: NO), the controller 30 finishes the process without doing anything since there is a possibility of damaging the discharging resistor 24 when the switch 22 is closed. On the other hand, in a case where the induced current Irm is less than the second current threshold Ith2 (S4: YES), the controller 30 compares a decreasing rate Irm of the induced current with a previously determined decreasing rate threshold dIth (S6). When the decreasing rate dIrm of the induced current is smaller than the decreasing rate threshold dial (S6: NO), that is, in a case where the induced current Irm is reduced gradually, the controller 30 finishes the process without doing anything. On the other hand, in a case where the decreasing rate dIrm of the induced current is greater than the decreasing rate threshold dIth (S6: YES), that is, in a case where the induced current Irm is rapidly reduced, the controller 30 closes the switch 22 of the discharging circuit (S8). The decreasing rate of the induced current corresponds to a reduction amount of the induced current Irm per unit time. The controller 30 always monitors sensor data of the current sensor 14, and calculates the decreasing rate of the induced current dIrm from a measured value at a preceding time and a measured value at a current time. Also, the decreasing rate threshold dIth is previously determined based on properties of the motor and the inverter and/or a property of the discharging resistor.

For the following explanation, a condition of step S2 in the process of FIG. 3 is referred to as a first condition, and a combination of a condition of step S4 and a condition of S6 is referred to as a second condition.

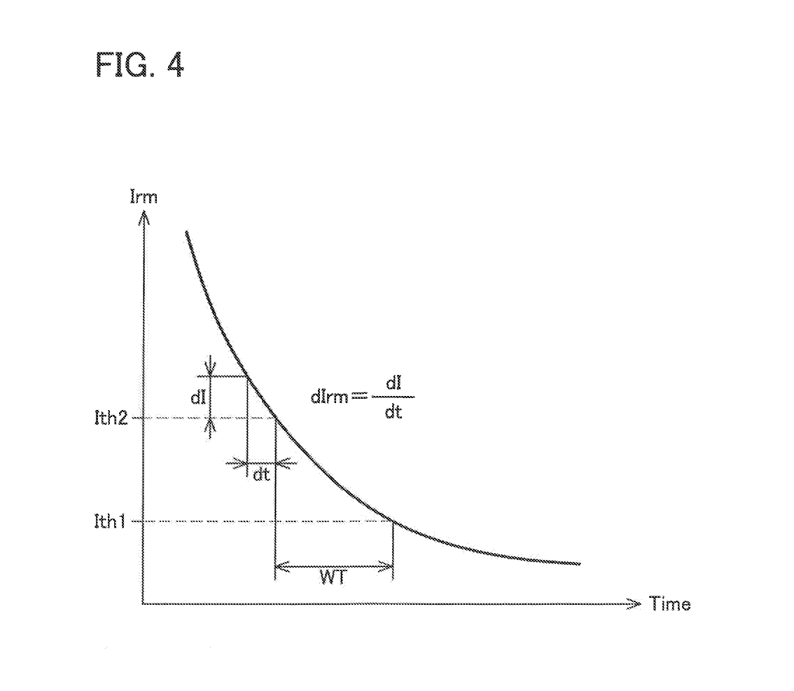

An advantage of the discharging process will be explained in reference to FIG. 4. FIG. 4 is a graph showing an example of a change in the induced current Irm caused by the hack electromotive force of the motor. When the vehicle collides with an obstacle, or when some abnormality is brought about, the HV controller (or other controller) stops the inverter. Consequently, rotation of the wheel (that is, rotation of the motor) is gradually reduced. The induced current Irm is also gradually reduced in accordance with the reduction in the motor rotation. The first current threshold Ith1 is set to a value obtained by subtracting current anticipated to flow from the capacitors C1 and C2 from a maximum current which can flow constantly to the discharging circuit 20 (discharging resistor 24). Therefore, in a case of executing the processing operation at step S8 successive to the processing operation at step S2 (that is, in a case of activating the discharging circuit 20 by establishing the first condition), only current smaller than the first current threshold Ith1 flows to the discharging resistor 24, and the discharging resistor 24 is not damaged. In a case where the processing operation at step S8 is executed via steps S4 and S6 (that is, in a case where the discharging circuit 20 is activated by establishing the second condition), a current greater than the first current threshold Ith1 temporarily flows to the discharging resistor 24. However, it is predicted that the current flowing to the discharging resistor 24 will be rapidly reduced by the determination at step S6. Consequently, although the current flowing to the discharging resistor 24 is greater than the first current threshold Ith1 at first, the current is rapidly reduced to be less than the first current threshold Ith1, and therefore, a possibility of damaging the discharging resistor 24 is inconsiderable. Further, as shown in FIG. 4, a timing of activating the discharging circuit by establishing the second condition is earlier than a timing of activating the discharging circuit by establishing the first condition by a time period WT. The discharging circuit 20 can be used more effectively than in the case of only the first condition by adopting the second condition. Meanwhile, the controller 30 repeatedly executes the processing operation of FIG. 3 until the discharging circuit 20 is activated at least at once after being inputted a signal indicating collision or abnormality. Consequently, for example, even in a case where the decreasing rate dIrm of the induced current is always less than the decreasing rate threshold dIth (step S6: NO), that is, even in a case where the rotation of the motor is gradually reduced, the controller 30 activates the discharging circuit 20 when the induced current Irm is reduced to be less than the first current threshold Ith1.

According to the embodiment, sensor data of the current sensor 14 is used for determining whether the discharging circuit 20 is activated. The induced current caused by the back electromotive force can be predicted from a rotational number of the motor. Also, the motor MG is attached with a resolver (not illustrated) for measuring the rotational number. However, the use of the current sensor 14 achieves the following advantage in addition to an advantage of capable of measuring the induced current directly and accurately. Modules necessary for determining whether the discharging circuit 20 is activated are the voltage converter 12, the discharging circuit 20, the inverter 13, the current sensor 14, and the controller 30. All of the modules are contained in a case of the power controller 2. A possibility of firmly operating the modules in the emergency is higher in a case of concentrating the modules in the single case than in a case of dispersing the modules in plural cases.

Points to keep in mind for the technologies disclosed in the description will be mentioned. Although according to the embodiment, the hybrid vehicle 100 is pointed out as an example, the technology disclosed in the description is applicable also to an electric vehicle which does not include an engine. The discharging device is not limited to the discharging resistor. A device of converting electric energy to heat energy or other energy to dissipate will do.

Representative, non-limiting examples of the present invention have now been described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric vehicle.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

While specific examples of the present invention have been described above in detail, these examples are merely illustrative and place no limitation on the scope of the claims. The technology described in the claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. An electric vehicle comprising:
an inverter that converts DC power of a battery into AC power and outputs the AC power to a motor;
a capacitor connected between two input terminals of the inverter;
a discharging device for discharging the capacitor, the discharging device being connected in parallel with the capacitor;
a current sensor that measures induced current caused by back electromotive force of the motor; and
a controller;
wherein, when a signal indicating collision or abnormality is inputted, the controller activates the discharging device if the induced current is less than a predetermined current threshold, and does not activate the discharging device if the induced current is greater than the predetermined current threshold.

2. The electric vehicle of claim 1, wherein the controller activates the discharging device when either one of following two conditions is satisfied:
condition 1: the induced current is less than a first current threshold; or
condition 2: the induced current is less than a second current threshold which is greater than the first current threshold and a decreasing rate of the induced current is greater than a predetermined decreasing rate threshold.

3. The electric vehicle of claim 1, wherein:
the inverter, the capacitor, the discharging device, the current sensor and the controller are contained in one case.

4. The electric vehicle of claim 2, wherein:
the inverter, the capacitor, the discharging device, the current sensor and the controller are contained in one case.
